(19) United States
(12) Patent Application Publication
(10) Pub. No.: US 2016/0044770 A1
(43) Pub. Date: Feb. 11, 2016

(54) ION GENERATOR

(71) Applicant: KOGANEI CORPORATION, Tokyo (JP)

(72) Inventors: Yoshinari FUKADA, Koganei-shi, Tokyo (JP); Kazuyoshi ONEZAWA, Koganei-shi, Tokyo (JP)

(73) Assignee: Koganei Corporation, Koganei-shi, Tokyo (JP)

(21) Appl. No.: 14/782,930

(22) PCT Filed: Apr. 9, 2014
(86) PCT No.: PCT/JP2014/060242

§ 371 Date: Oct. 7, 2015

(30) Foreign Application Priority Data
Apr. 11, 2013 (JP) 2013-083022

(51) Int. Cl. H05F 3/06; H01T 23/00

(52) U.S. Cl. CPC H05F 3/06; H01T 23/00

(57) ABSTRACT

Provided is an ion generator that has a potential sensor provided integrally inside the main body of the ion generator, and that can measure, with the potential sensor, an electric field that reaches the potential sensor from a member from which static charge is to be eliminated, without being affected by an electric field between a discharge electrode and an opposing electrode. This ion generator comprises a discharge electrode, an opposing electrode, and a main body part including these electrodes, the ion generator sending out, toward a member from which static charge is to be eliminated, air ions generated by applying a high voltage between the electrodes. A potential sensor that measures the potential of the member from which static charge is to be eliminated is provided integrally to the main body part, and a projecting electrostatic-shielding plate that projects from the main body part is provided between the potential sensor and a discharge part constituted by the discharge electrode and the opposing electrode.

### TECHNICAL FIELD

The present invention relates to an ion generator that neutralizes charge of an electrically-charged body as an object required to be electrically neutralized (hereinafter “charged member”). The ion generator blows positive or negative air ions generated by corona discharge against the charged member. The present invention relates to, especially an ion generator having an integral potential sensor integrally provided therewith.

### BACKGROUND ART

The ion generator is called ionizer or static charge eliminator as well. The ion generator blows air ions against a charged target and eliminates charge. In a manufacture line in which manufacture and assembly of electronic components are conducted, electronic components and manufacture assembly jigs are charged. The electronic components and manufacture assembly jigs are regarded as a charged member, and the ion generator is used. Blowing air ions against the charged member prevents foreign matters from adhering to electronic components by static electricity, prevents electronic components from being destroyed by static electricity, and prevents foreign matters from adhering to jigs.

It is known to measure the potential of the charged member, by using a potential sensor (see, for example, Patent Literatures 1 and 2). If such a potential sensor is used together with the ion generator, it is possible to eliminate charge in the charged member, while measuring the potential of the charged member by using the potential sensor. Such a potential sensor is usually attached separately from the ion generator or externally to the ion generator and used.

### CITATION LIST

### Patent Literature

{PTL 1} Japan Unexamined Patent Application Publication 2012-242094

{PTL 2} Japan Unexamined Patent Application Publication 2010-85393

### SUMMARY OF THE INVENTION

### Technical Problem

In a case where the ion generator and the potential sensor are provided separately, the installation space is large. On the other hand, in a case where the ion generator and the potential sensor are provided integrally, the installation space is small. If the ion generator and the potential sensor are provided integrally, however, a problem is posed. For example, since a discharge electrode and an opposite electrode are disposed near the potential sensor, an electric field between the discharge electrode and the opposite electrode with a high voltage applied reaches the potential sensor. The electric field is superposed on an electric field that reaches the potential sensor from the charged member, i.e., an electric field to be measured, and becomes noise. Therefore, it is not possible to measure the potential of the charged member, accurately.

An object of the present invention is to provide, an ion generator that measures potential of a charged member, by using a potential sensor without being influenced by an electric field between a discharge electrode and an opposite electrode, i.e., noise, although the ion generator and the potential sensor are provided integrally.

### Solution to Problem

In order to solve the problem, the present invention provides an ion generator that blows air ions generated by applying a high voltage to a discharge unit including discharge electrodes and opposite electrodes, toward a charged member. The ion generator includes a potential sensor provided integrally in a main body unit to measure potential of the charged member, and a projecting electrostatic shield plate disposed between the discharge unit and the potential sensor to project from the main body unit.

It is possible to set a projection length of the projecting electrostatic shield plate in a range of 8 to 10 mm.

An aperture window is formed in the potential sensor to take in an electric field from the charged member. It is possible to set a distance from the projecting electrostatic shield plate to the aperture window in the potential sensor equal to 2 mm or less.

A blow-off opening is formed in the main body unit to blow off the air ions. A plurality of the discharge electrodes is disposed at intervals along the blow-off opening. It is possible to cause the projecting electrostatic shield plate to intervene between any of the discharge electrodes and the aperture window.

It is possible to cause the blow-off opening and the aperture window to be disposed on the same plane in the main body.

### Advantageous Effects of the Invention

In the ion generator according to the present invention, the potential sensor is provided integrally in the main body unit. Potential of the charged member is measured by the potential sensor. The discharge unit includes the discharge electrodes and the opposite electrodes. The projecting electrostatic shield plate is provided between the discharge unit and the potential sensor. The projecting electrostatic shield plate projects toward an ion blow-off direction from the main body unit. The high voltage is applied between the discharge electrode and the opposite electrode, and an electric field is generated. The electric field is shielded by the projecting electrostatic shield plate, and the electric field does not reach the potential sensor. Therefore, the potential of the charged member is measured by the potential sensor without being influenced by the electric field between the discharge electrode and the opposite electrode, i.e., noise.

### BRIEF DESCRIPTION OF DRAWINGS

FIG. 1 is a general perspective view obtained by viewing an ion generator according to an embodiment of the present invention from a front side.

FIG. 2 is a general perspective view obtained by viewing the ion generator illustrated in FIG. 1 from a rear side;

FIG. 3 is a front view of the ion generator.

FIG. 4 is a plan view of FIG. 3.

FIG. 5 is a rear view of FIG. 3.

FIG. 6 is a perspective view illustrating a single substance of a discharge electrode unit.

FIG. 7 is a sectional view taking along line A-A in FIG. 1.

FIG. 8 is an enlarged view of an X portion in FIG. 3.

FIG. 9 is a perspective view of FIG. 8.

FIG. 10 is a perspective view illustrating the whole of a potential sensor.

FIG. 11 is a plan view illustrating a configuration of the potential sensor.

FIG. 12 is a front sectional view of the potential sensor illustrated in FIG. 11, illustrating a state in which the potential sensor is cut along a line indicated by arrows 2-2.

FIG. 13 is a side sectional view of the potential sensor illustrated in FIG. 11, illustrating a state in which the potential sensor is cut along a line indicated by arrows 3-3.

FIG. 14 is a plan view of the potential sensor illustrated in FIG. 11 in a state in which an electrostatic shield plate is removed.

FIG. 15 is a side view of the potential sensor illustrated in FIG. 11 in the state in which the electrostatic shield plate is removed.

FIG. 16 is a diagram illustrating relations between a position of a projecting electrostatic shield plate and a projection length thereof.

FIG. 17 is a graphic diagram illustrating relations between the length of the projecting electrostatic shield plate and noise voltage.

FIG. 18 is a graphic diagram illustrating relations between the length of the projecting electrostatic shield plate and signal voltage.

### DESCRIPTION OF EMBODIMENTS

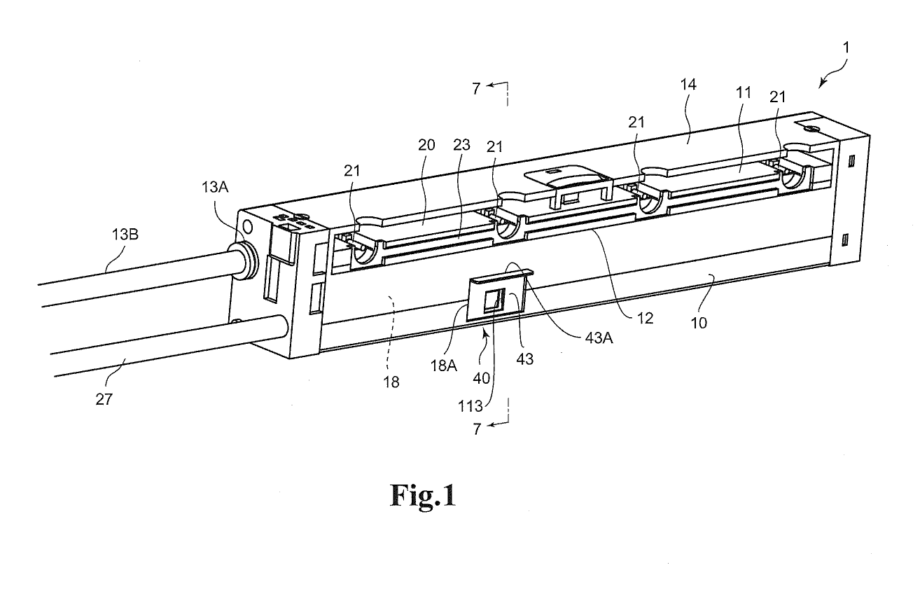

Hereafter, an ion generator according to an embodiment of the present invention will be described in detail with reference to the drawings. “Up-down direction,” “left/right direction (width direction),” and “depth direction” used in the following description refer to directions viewed from a front side where the front side (surface side) is this side in FIG. 1. In the embodiment stated hereafter, a product of wide type will be described. The product of wide type blows off generated air ions from a laterally long blow-off opening.

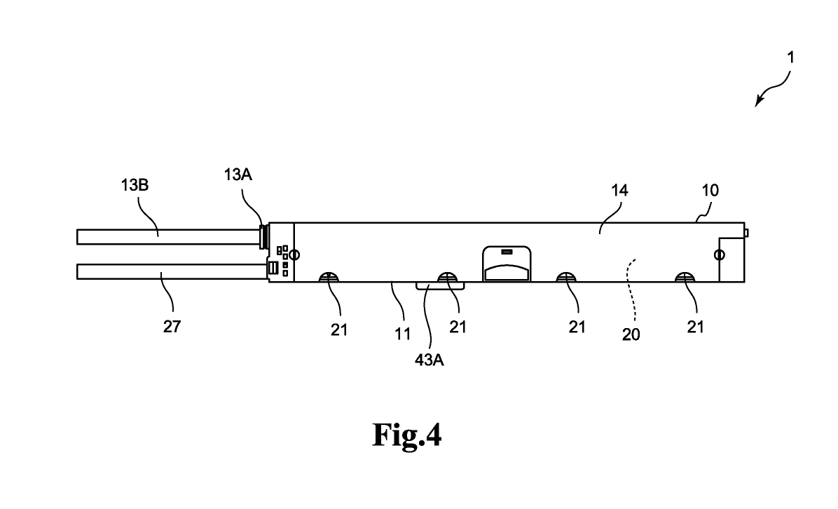

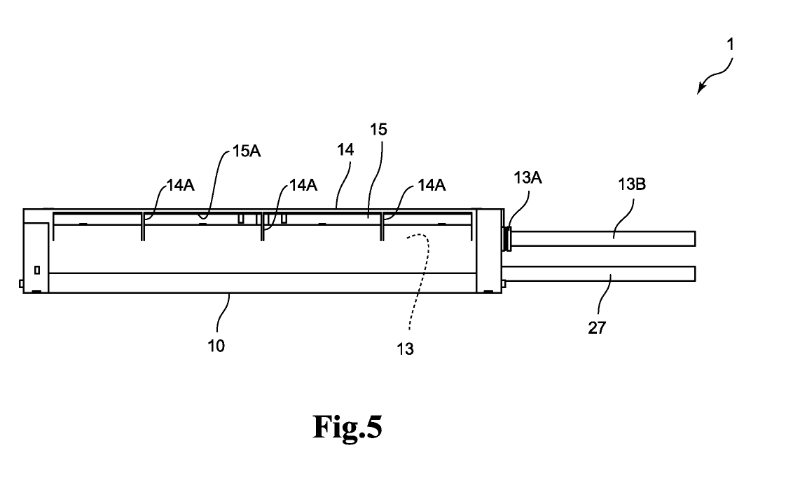

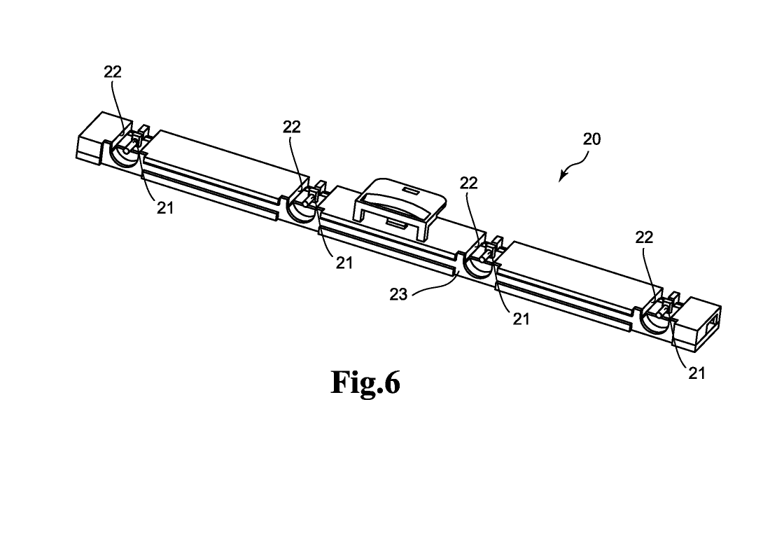

The whole of an ion generator 1 is illustrated in FIGS. 1 to 5. The ion generator 1 includes a main body unit 10, a discharge electrode unit 20 (see FIG. 6), and a potential sensor unit 40. The discharge electrode unit 20 is detachably attached to the main body unit 10 from a blow-off opening 11. The potential sensor unit 40 is housed in the main body unit 10.

The main body unit 10 is formed into the shape of nearly a rectangular parallelepiped, and the main body unit 10 extends in the left/right direction. As illustrated in FIGS. 1, 3, 4 and 7, the blow-off opening 11 is formed in an upper portion of the front of the main body unit 10 on this side. The blow-off opening 11 extends in the left/right direction.

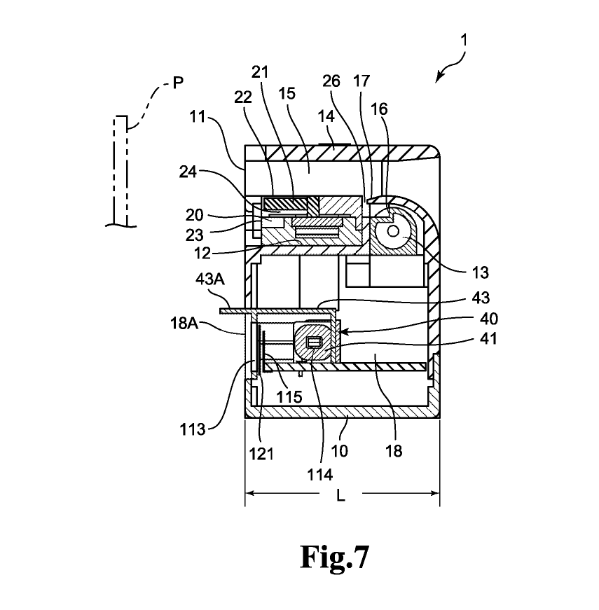

As illustrated in FIG. 7, a discharge electrode unit mounting portion 12 is formed within the rear portion of the blow-off opening 11. The discharge electrode unit mounting portion 12 is recessed in the depth direction, and has the same width as that of the blow-off opening 11. The discharge electrode unit mounting portion 12 is formed into a rectangular recessed shape. The discharge electrode unit 20 (see FIG. 6) is fitted in the discharge electrode unit mounting portion 12.

As illustrated in FIG. 7, an air supply chamber 13 is provided further behind the discharge electrode unit mounting portion 12. The air supply chamber 13 is formed over the whole length of the blow-off opening 11 in the left/right direction. As illustrated in FIGS. 1 to 5, the air supply chamber 13 is supplied with jet air from an air supply port 13A provided on a left side of the main body unit 10 via a tube 13B.

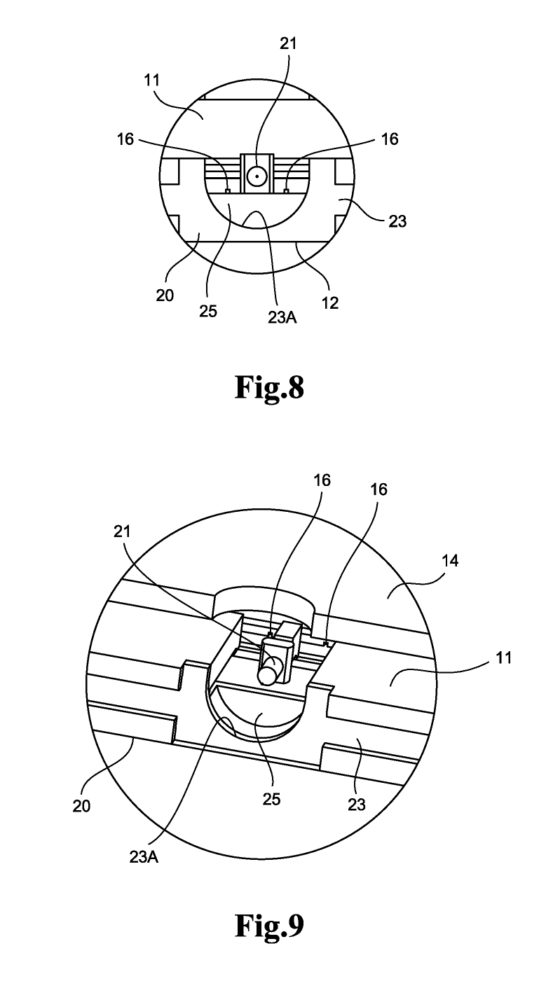

As illustrated in FIGS. 7 to 9, an air discharge opening 16 is provided in an upper portion of the front side of the air supply chamber 13. The air discharge opening 16 communicates from inside of the air supply chamber 13 to a back portion of the discharge electrode unit mounting portion 12. The air discharge opening 16 takes the shape of a rectangular hole or a round hole. As illustrated in FIGS. 8 and 9, two air discharge openings 16 are provided on lower sides of the left and right of each of discharge electrodes 21. Details of the air discharge openings 16 will be described later. The jet air is jetted forward from the air discharge openings 16.

As illustrated in FIG. 7, an air guide portion 17 is provided on an upper portion of the air discharge opening 16. The air guide portion 17 projects to the upper side of the front of the air discharge opening 16. The air guide portion 17 enhances the straight advancing property of the jet air blown off from the air discharge opening 16.

A top face cover 14 is provided over the air supply chamber 13 and the discharge electrode unit mounting portion 12. As illustrated in FIGS. 1 to 3, 5 and 7, an air flow path 15 is formed between the top face cover 14 and the air supply chamber 13. The air flow path 15 is also formed between the top face cover 14 and the discharge electrode unit mounting portion 12. The air flow path 15 passes through from a back face of the main body unit 10 to a front face. The air flow path 15 is parallel to a direction in which the above-described air guide portion 17 leads the jet air. In other words, a direction of the jet air flow discharged from the air discharge opening 16 becomes the same as a direction of flow of an external air which flows in the air flow path 15. The external air is an air rolled from the circumference of the ion generator 1 by the flow of the jet air.

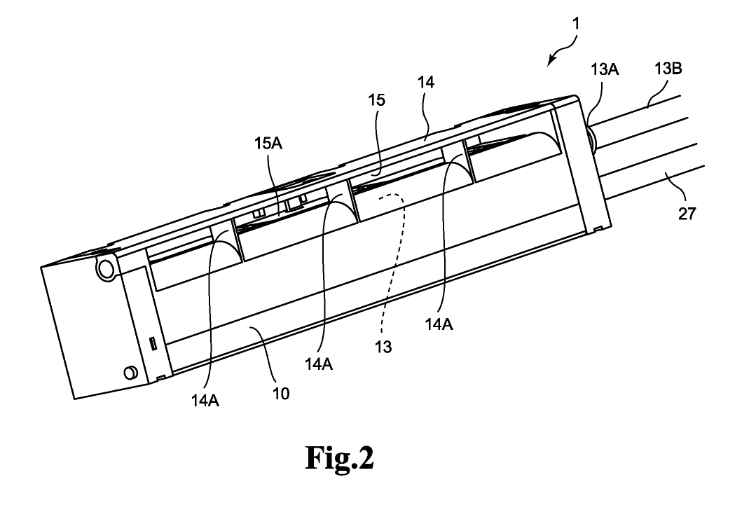

As illustrated in FIGS. 2, 5 and 7, an upper portion of the air supply chamber 13 is formed into a curved shape. As a result, an inlet 15A on the rear face side of the air flow path 15 is spread toward behind. As a result, it is facilitated to take external air behind the ion generator 1 into the air flow path 15.

On the other hand, as illustrated in FIG. 6, a plurality of (four in FIG. 6) discharge electrodes 21 is disposed in the discharge electrode unit 20 at intervals. The discharge electrode 21 is formed in a fine wire form or a needle form. The rectilinear discharge electrode 21 extends toward the blow-off opening 11 on this side in FIG. 6. Opening portion 22 are formed on a top face of the discharge electrode unit 20 to correspond to respective discharge electrodes 21. The respective discharge electrodes 21 is exposed from the top face of the discharge electrode unit 20 via the opening portion 22.

As illustrated in FIGS. 1, 3 and 6 to 9, an opposite electrode 23 is provided on the front side of the discharge electrode unit 20. The opposite electrode 23 is formed of metal having conductivity and formed into the shape of a plate. The opposite electrode 23 is disposed in a lengthwise direction of the discharge electrode unit 20.

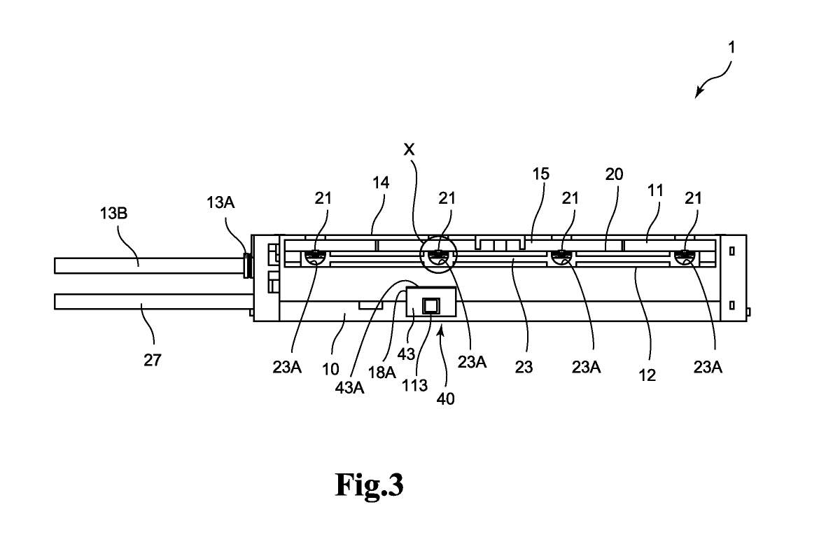

As illustrated in FIGS. 3, 6, 8 and 9, the opposite electrode 23 is provided on a side lower than the discharge electrode 21 when viewed from the front side of the ion generator 1. A notched portion 23A is formed in a nearly half circle shape centered the discharge electrode 21 to correspond to the discharge electrode 21. In other words, the discharge electrode 21 and the opposite electrode 23 are disposed via a gap 25 having a determinate length interposed therebetween.

As illustrated in FIG. 7, an air supply path 24 is formed within the discharge electrode unit 20. The jet air flows through the air supply path 24 which extends from the air discharge opening 16 toward the gap 25.

As illustrated in FIG. 7, a separation space 26 is provided in a state in which the discharge electrode unit 20 is attached to the main body unit 10. The separation space 26 is a space extending from a front side tip portion of the air guide portion 17 to a back end portion of the air supply path 24. The jet air flows fast from the air discharge opening 16 toward the air supply path 24. The jet air flowing fast and the external air in the air flow path 15 are brought into contact with each other in the separation space 26 and the opening portion 22.

Power is supplied from an external power supply to the ion generator 1 via a power supply cable 27 (see FIG. 1). A high voltage is applied between the discharge electrode 21 and the opposite electrode 23. As a result, corona discharge occurs and air ions are generated. As for an internal configuration for applying a high voltage, detailed description thereof will be omitted.

As illustrated in FIG. 7, a potential sensor unit housing portion 18 is provided on a lower side within the main body unit 10, i.e., under the air supply chamber 13 and the discharge electrode unit mounting portion 12. The potential sensor unit housing portion 18 is provided over the left/right direction of the ion generator 1. A detection window 18A is provided in a front side wall of the potential sensor unit housing portion 18. The detection window 18A communicates with the potential sensor unit housing portion 18. The potential sensor unit 40 is attached to the potential sensor unit housing portion 18. The potential sensor unit 40 measures the potential of the charged member P disposed opposite to the blow-off opening 11.

The potential sensor unit 40 includes a potential sensor 41 and a power supply unit (not illustrated) that supplies power to the potential sensor 41. The potential sensor 41 and the power supply unit are attached within the potential sensor unit housing portion 18.

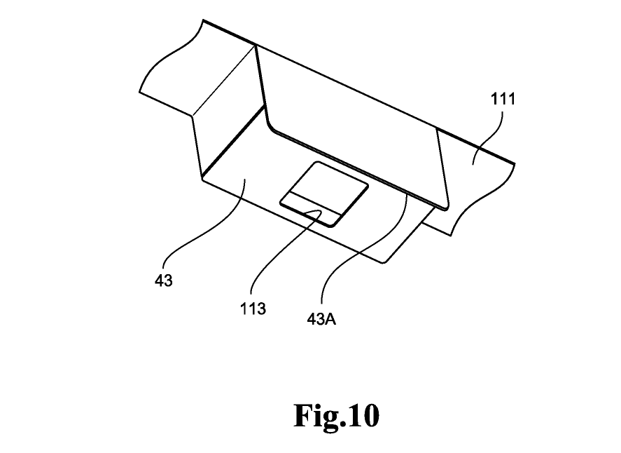

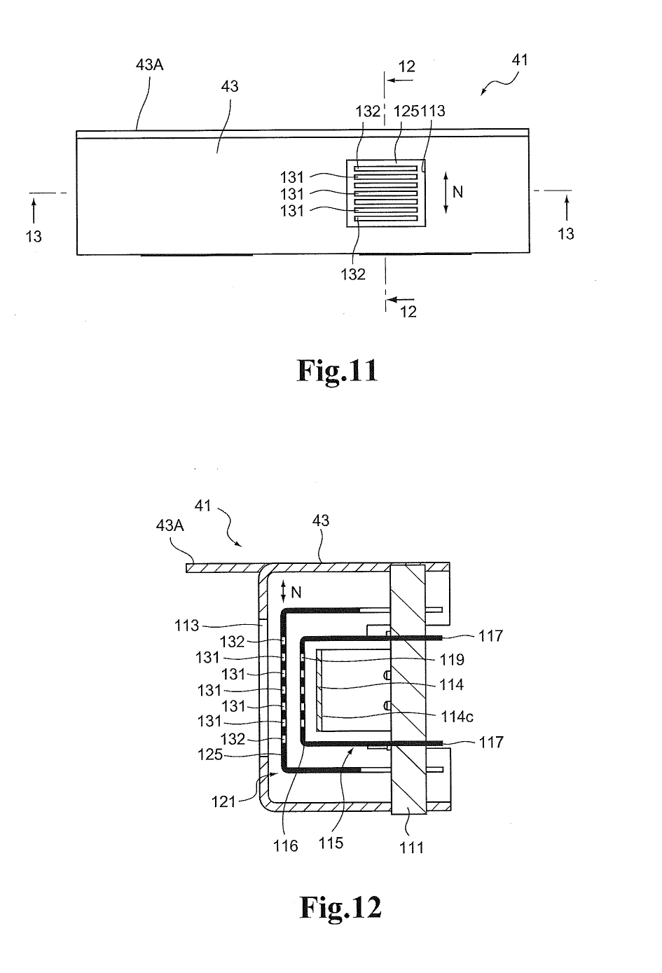

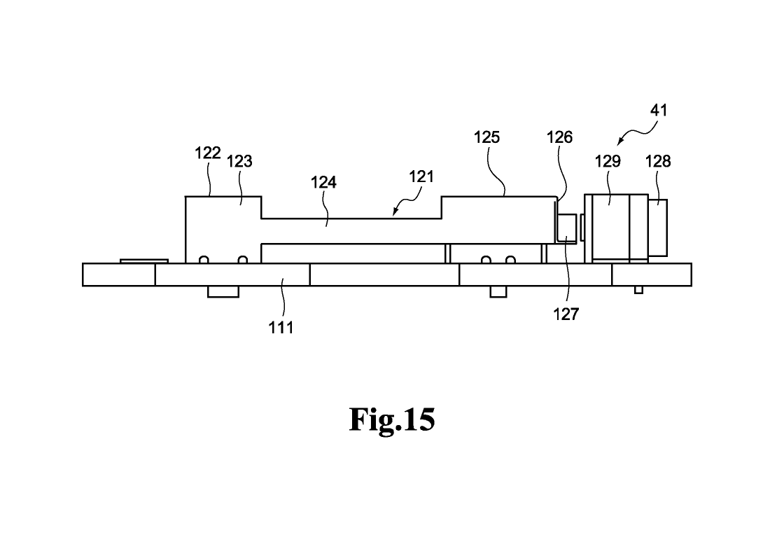

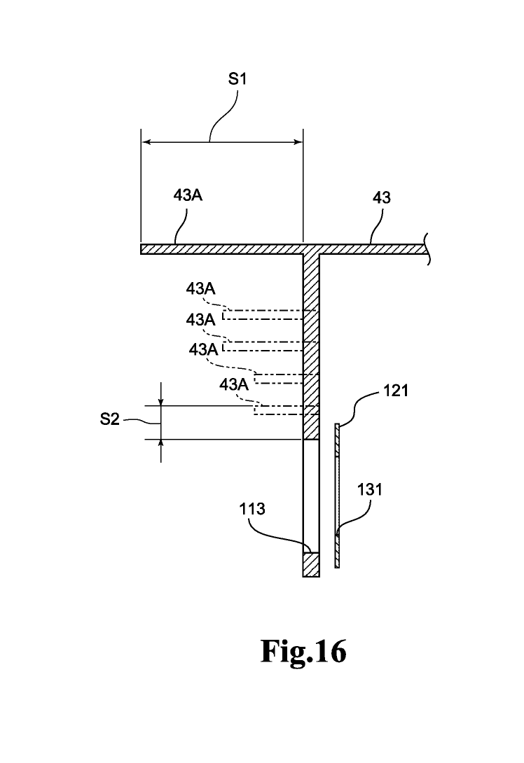

As illustrated in FIG. 10, the potential sensor 41 includes a printed circuit board 111 on which a detection electrode 114 (see FIG. 12) and so forth are mounted, and an electrostatic shield plate 43 to which the printed circuit board 111 is attached. A lengthwise direction of the printed circuit board 111 extends in the left/right direction of the main body unit 10 in the ion generator 1. By the way, as for the printed circuit board 111 illustrated in FIGS. 11 to 15, a portion is illustrated, and other portions are omitted.

A rectangular shaped aperture window 113 is formed in the electrostatic shield plate 43. As illustrated in FIG. 11, the aperture window 113 is formed by notching the electrostatic shield plate 43. All main slits 131 are exposed to the outside via the aperture window 113, and all main slits 131 is visible from the outside. A position of the aperture window 113 coincides with a position of the detection window 18A in the potential sensor unit housing portion 18.

As illustrated in FIGS. 10 to 12, a projecting electrostatic shield plate 43A is provided continuously from the electrostatic shield plate 43. The projecting electrostatic shield plate 43A is provided over the whole length in the left/right direction of the electrostatic shield plate 43. The projecting electrostatic shield plate 43A is projected from the ion generator 1. Details of the projecting electrostatic shield plate 43A will be described later.

As illustrated in FIGS. 11 to 13, the detection electrode 114 is attached to the printed circuit board 111. A flange portion 114a of the detection electrode 114 is fixed to the printed circuit board 111. In addition, a standing portion 114b extending from the flange portion 114a is nearly perpendicular to the printed circuit board 111. An electrode portion 114c extends from the standing portion 114b in parallel with the printed circuit board 111. The electrode portion 114c opposes to the aperture window 113. The detection electrode 114 is one of elements included in a detection circuit (not illustrated). At least the electrode portion 114c included in the detection electrode 114 forms an electric field between a charged substance and the electrode portion 114c.

A fixed shutter 115 made of a conductive material is attached to the printed circuit board 111. The fixed shutter 115 covers the detection electrode 114. A main body portion 116 of the fixed shutter 115 is provided in parallel with the electrode portion 114c of the detection electrode 114. The main body portion 116 is formed into a nearly rectangular shape. Side wall portions 117 and end wall portions 118 are bent from the main body portion 116 at right angles and are integral with the main body portion 116. As illustrated in FIG. 12, tip portions of the side wall portions 117 are inserted into mounting holes formed through the printed circuit board 111, and the fixed shutter 115 is fixed to the printed circuit board 111.

Aperture slits 119 are formed in the main body portion 116 of the fixed shutter 115. The aperture slits 119 extend in the lengthwise direction (left/right direction) of the electrostatic shield plate 43. Five aperture slits 119 are formed in a width direction (up-down direction) of the main body portion 116. The aperture slits 119 are disposed at constant intervals.

As illustrated in FIGS. 12 to 15, a movable shutter 121 is provided on the printed circuit board 111. The movable shutter 121 is provided outside the fixed shutter 115 to cover the fixed shutter 115. The movable shutter 121 moves between two positions: a full open position in which the slits 131 and slits 132 of the movable shutter 121 coincide with the aperture slits 119 of the fixed shutter 115, and an interruption position in which the aperture slits 119 of the fixed shutter 115 are closed. A change of an aperture area of the shutters depending upon the full open position and the interruption position gives a change in an electric field formed between a charged substance and the detection electrode 114 (the electrode portion 114c).

A center line (not illustrated) of the aperture slits 119 in the lengthwise direction (left/right direction) is referred to as aperture slit center line. A center line (not illustrated) of the slits 131 and 132 in the lengthwise direction (left/right direction) is referred to as main slit center line. A position of the movable shutter 121 in which the aperture slit center line and the main slit center line coincide with each other is referred to as “full open position.”

A center line in the lengthwise direction (left/right direction) of a shield portion (reference numeral is omitted) existing between two main slits 131 is referred to as main shield portion center line. A center line (not illustrated) in the lengthwise direction (left/right direction) of a shield portion (reference numeral is omitted) existing between a main slit 131 and a subsidiary slit 132 is referred to as subsidiary shield portion center line. A position of the movable shutter 121 in which the aperture slit center line coincides with the main shield portion center line or the subsidiary shield portion center line is referred to as “interruption position.”

The movable shutter 121 is formed of a material having conductivity. The movable shutter 121 reciprocates in an open-close direction (up-down direction). The movable shutter 121 includes a fixed end portion 122 fixed to the printed circuit board 111. Leg pieces 123 are integrally provided on both sides of the fixed end portion 122. The leg pieces 123 are inserted into mounting holes formed in the printed circuit board 111. The fixed end portion 122 of the movable shutter 121 is attached to the printed circuit board 111.

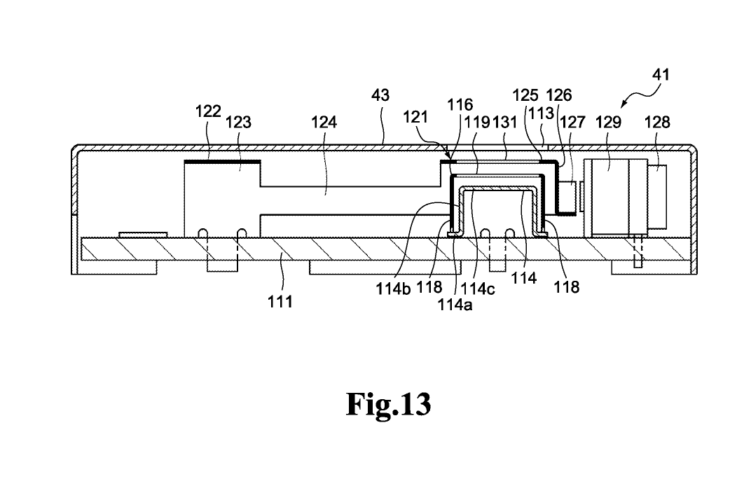

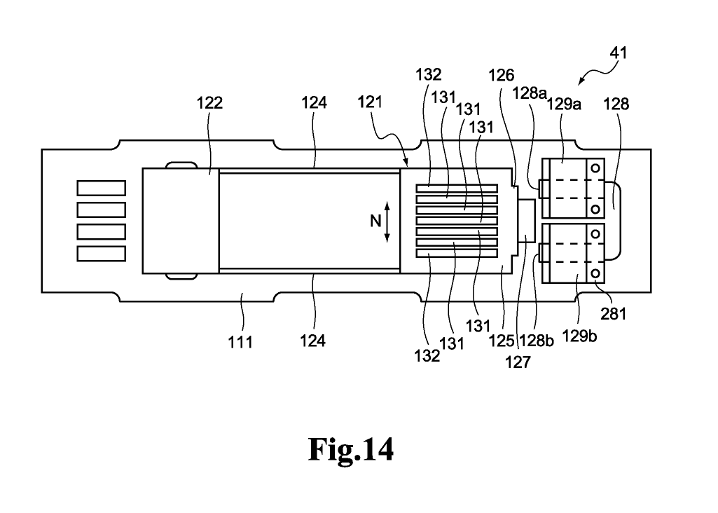

An arm portion 124 is provided integrally in each of the leg pieces 123 in the fixed end portion 122. The arm portion 124 extends to one end side (right side) in the lengthwise direction (left/right direction) of the printed circuit board 111. As illustrated in FIG. 14, two arm portions 124 are provided at a predetermined interval in the present embodiment. Each of the arm portions 124 is formed of a flexible plate shaped member. A main body portion 125 is provided integrally on tips of the arm portions 124. As illustrated in FIGS. 12 and 13, the main body portion 116 of the fixed shutter 115 is disposed outside the detection electrode 114. The main body portion 116 covers the detection electrode 114. The main body portion 125 of the movable shutter 121 is disposed outside the fixed shutter 115. In addition, the main body portion 125 is exposed to the outside via the aperture window 113. The main body portion 125 of the movable shutter 121 reciprocates in an open-close direction indicated by an arrow N, and opens and closes the aperture slits 119.

At least the main body portion 116 of the fixed shutter 115 is grounded. And at least the main body portion 125 of the movable shutter 121 is also grounded.

As illustrated in FIGS. 13 and 14, a magnet 127 functioning as a magnetic substance is attached to an end wall 126 provided integrally in the main body portion 125. The magnet 127 has a function of driving the movable shutter 121 to open and close. As indicated by solid lines and dashed lines in FIG. 14, a U-shaped yoke 128 is attached to one end side (right side) of the printed circuit board 111. One pair of coils 129a and 129b is wound round the yoke 128 via bobbins 281. The coils 129a and 129b are connected to a power supply unit, which is not illustrated. An alternating current is flown through each of the coils 129a and 129b. As a result, magnetic fields that are inverse in direction to each other are formed on two magnetic pole surfaces 128a and 128b. Therefore, the magnet 127 moves between a position opposed to one magnetic pole surface 128a and a position opposed to the other magnetic pole surface 128b. In this way, a drive means that drives the movable shutter 121 in the reciprocation direction N to open and close is formed by the coils 129a and 129b wound round the yoke 128 and the magnet 127.

Five main slits 131 are formed in the main body portion 125 in the movable shutter 121. The five main slits 131 correspond to the five aperture slits 119 formed in the fixed shutter 115. The respective main slits 131 extend in the same direction as that of the aperture slits 119. Adjacent main slits 131 are disposed at a constant interval. The interval is the same as that of the aperture slits 119.

The movable shutter 121 conducts reciprocal vibration, and moves between the full open position and the interruption position.

FIG. 12 illustrates a state in which the movable shutter 121 is in a neutral position. At this time, all of the five main slits 131 are opposed to the aperture slits 119. One subsidiary slit 132 is formed on each of outsides of main slits 131 located on both ends of the reciprocation direction N (up-down direction). Each subsidiary slit 132 takes the same shape as that of the main slit 131. Intervals between the five main slits 131 are the same as intervals between the main slits 131 and the subsidiary slits 132. The five main slits 131 and the two subsidiary slits 132 take the same shape. These seven slits 131 and 132 formed on the movable shutter 121 take the same shape as that of the aperture slits 119 formed on the fixed shutter 115. When the movable shutter 121 reciprocates, therefore, the aperture slits 119 are opened and closed by the subsidiary slits 132.

In this way, one subsidiary slit 132 is formed on the outside of the two main slits 131 located at both ends of the reciprocation direction N, i.e., in an extension direction of the reciprocation direction N. During one period of movement of the movable shutter 121, the movable shutter 121 moves from the neutral position illustrated in FIG. 12 to a reciprocation end in a left direction in FIG. 12, then the movable shutter 121 moves to a position of a reciprocation end in a right direction, and returns to the neutral position. During the one period, the five aperture slits 119 on the fixed shutter 115 are opened and closed four times. In other words, the aperture slits 119 are opened and closed with a frequency that is four times the drive frequency of the movable shutter 121.

A current detection circuit is connected to the detection electrode 114. In a state in which the detection electrode 114 is opposed to a charged substance via the aperture window 113, an alternating current in the range of, for example, 600 to 800 Hz is applied to the coils 129a and 129b to cause the movable shutter 121 to conduct reciprocal vibration. As a result, the aperture slits 119 on the fixed shutter 115 are opened and closed with a frequency that is four times the drive frequency of the movable shutter 121. With this open/close frequency, an electric field between the detection electrode 114 and the charged substance changes, and an alternating voltage is generated in the detection electrode 114.

The projecting electrostatic shield plate 43A provided on the electrostatic shield plate 43 will now be described. In the ion generator 1 with the potential sensor 41 integrally mounted thereon, charge elimination is conducted by blowing generated air ions against the charged member P (see FIG. 7). At the same time, the potential sensor 41 measures surface potential of the charged member P. In other words, since the ion generator 1 and the potential sensor 41 are provided in the same casing, it is more convenient to use as compared with the case where the ion generator 1 and the potential sensor 41 are provided separately.

It is necessary to dispose both the blow-off opening 11 of air ions and the potential sensor 41 to be opposed to the charged member P. Therefore, the discharge unit (the discharge electrodes 21 and the opposite electrodes 23) and the aperture window 113 of the potential sensor 41 are provided on the same plane of the main body unit 10. As a result, not only an electric field from the charged member P but also an electric field between the discharge electrode 21 and the opposite electrode 23, i.e., a discharge electric field reaches the potential sensor 41. The discharge electric field becomes noise. In the present embodiment, the blow-off opening 11 and the aperture window 113 of the potential sensor 41 are provided on the same plane of the main body unit 10. In addition, the projecting electrostatic shield plate 43A is projected and provided between the blow-off opening 11 and the aperture window 113 to conduct electrostatic shielding between the discharge unit and the potential sensor 41.

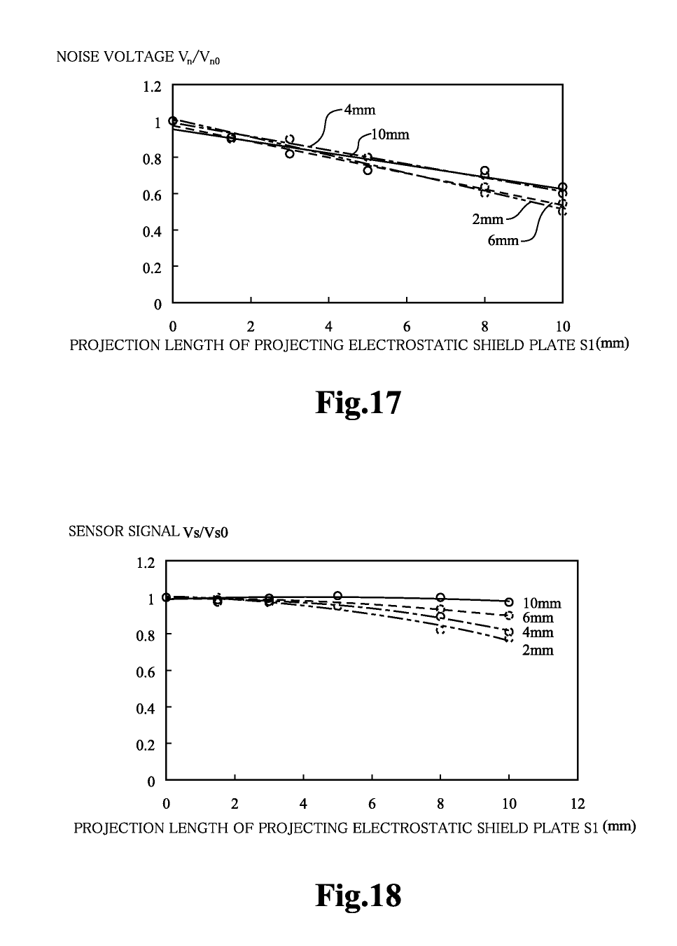

A length S1 of the forward projection of the projecting electrostatic shield plate 43A influences a noise voltage and a signal voltage of the potential sensor 41. Graphs in FIG. 17 represent a ratio of a noise voltage Vn to Vn0 (Vn/Vn0) and a projection length S1 of the projecting electrostatic shield plate 43A, where Vn0 is the noise voltage in a case where the projection length S1 of the projecting electrostatic shield plate 43A is 0 mm. A distance S2 (2, 4, 6 and 10 mm) between the projecting electrostatic shield plate 43A and the aperture window 113 is set to be a parameter. The ratio Vn/Vn0 does not largely depend upon the distance S2 between the projecting electrostatic shield plate 43A and the aperture window 113. The ratio Vn/Vn0 decreases, the longer the projection length S1 of the projecting electrostatic shield plate 43A is made. For example, in a case where the projection length S1 of the projecting electrostatic shield plate 43A is set equal to 8 or 10 mm, Vn/Vn0 decreases to 35% or 50%.

Graphs in FIG. 18 represent a ratio of a sensor signal voltage Vs to Vs0 (Vs/Vs0) and a function of the projection length S1 of the projecting electrostatic shield plate 43A, where Vs0 is the signal voltage in a case where the projection length S1 of the projecting electrostatic shield plate 43A is 0 mm. A distance S2 (2, 4, 6 and 10 mm) between the projecting electrostatic shield plate 43A and the aperture window 113 is set to be a parameter. In a case where the distance S2 between the projecting electrostatic shield plate 43A and the aperture window 113 is as short as 2 mm, the signal decreases by approximately 20% as compared with a case where the distance is 10 mm.

The length of the projecting electrostatic shield plate 43A in the left/right direction is made long enough to be also effective to a plurality of discharge electrodes 21 disposed at intervals along the lengthwise direction of the blow-off opening 11. Relations between the length of the projecting electrostatic shield plate 43A and the distance S2 between the projecting electrostatic shield plate 43A and the aperture window 113 will be described hereafter. When the projection length of the projecting electrostatic shield plate 43A is prolonged gradually from 0 mm to 10 mm, attenuation of the sensor signal is in the range of 0% to at most approximately 20% (the distance S2=2 mm). Whereas attenuation of the noise voltage is in the range of 30% (the distance S2=10 mm) to 50% (the distance S2=2 mm). In other words, the sensor signal attenuates little whereas the attenuation of the noise voltage is large. Especially in a case where the projecting electrostatic shield plate 43A and the aperture window 113 are made close to each other so as to have the distance S2 that is approximately 2 mm and the projection length of the projecting electrostatic shield plate 43A is set equal to 10 mm, attenuation of the sensor signal is approximately 20%. On the other hand, attenuation of the noise voltage is approximately 50%. Therefore, the signal to noise ratio is improved by 0.8=0.5=1.6, i.e., 60%.

In the ion generator according to the embodiment of the present invention, the potential sensor 41, which measures the potential of the charged member P, is provided integrally in the main body unit 10. In addition, the projecting electrostatic shield plate 43A projecting from the main body unit 10 is provided between the discharge unit formed of the discharge electrodes 21 and the opposite electrodes 23, and the potential sensor 41. Therefore, the electric field between the discharge electrode 21 and the opposite electrode 23 is electrostatically shielded by the projecting electrostatic shield plate 43A. Accordingly, the electric field is hard to reach the potential sensor 41. As a result, superposition of noise caused by the electric field between the discharge electrode 21 and the opposite electrode 23 on a value measured by the potential sensor 41 is suppressed. Therefore, the voltage of the charged member P is measured accurately.

The discharge unit formed of the discharge electrodes 21 and the opposite electrodes 23, and the aperture window 113 of the potential sensor 41 are disposed on the same plane. As a result, a depth dimension L (see FIG. 7) of the ion generator 1 can be made small. Accordingly, it becomes possible to design an ion generator 1 having a smaller size.

The projection length S1 of the projecting electrostatic shield plate 43A is set in the range of 8 to 10 mm from the aperture window 113 of the potential sensor 41. As compared with the case where the projecting electrostatic shield plate 43A is not provided, therefore, it is possible to decrease the ratio of the noise voltage Vn to Vn0 represented by Vn/Vn0 to a range of 35 to 50%. In addition, the distance S2 from the projecting electrostatic shield plate 43A to the aperture window 113 is set equal to or less than 2 mm. As a result, it is possible to suppress the decrease in the ratio of the signal voltage Vs to Vs0 represented by Vs/Vs0 to approximately 20%.

In addition, the blow-off opening 11 is formed to be long. And a plurality of discharge electrodes 21 is disposed at intervals along the lengthwise direction of the blow-off opening 11. In such a configuration, the projecting electrostatic shield plate 43A is made to intervene between all of the discharge electrodes 21 and the aperture window 113. As a result, it is possible to suppress noise generation effectively.

Heretofore, the ion generator according to the embodiment of the present invention has been described. However, the present invention is not restricted to the embodiment described above, but various modifications and changes can be made on the basis of the technical thought of the present invention.

For example, in the present embodiment, the ion generator 1 having a plurality of discharge electrodes 21 along the lengthwise direction has been described. However, the present invention can also be applied to an ion generator having one discharge electrode 21 (an ion generator that blows off air ions in a spot way).

### REFERENCE SIGNS LIST

1 Ion generator
10 Main body unit
11 Blow-off opening
12 Discharge electrode unit mounting portion
13 Air supply chamber
13A Air supply port
13B Tube
14 Top face cover
15 Air flow path
16 Air discharge opening
17 Air guide portion
18 Potential sensor unit housing portion
18A Detection window
20 Discharge electrode unit
21 Discharge electrode
22 Opening portion
23 Opposite electrode
24 Air supply path
25 Gap
26 Separation space
27 Power supply cable
40 Potential sensor unit
41 Potential sensor
43 Electrostatic shield plate
43A Projecting electrostatic shield plate
111 Printed circuit board
113 Aperture window
114 Detection electrode
114a Flange portion
114b Standing portion
114c Electrode portion
115 Fixed shutter
116 Main body portion
117 Side wall portion
118 End wall portion
119 Aperture slit
121 Movable shutter
122 Fixed end portion
123 Leg piece
124 Arm portion
125 Main body portion
126 End wall
127 Magnet
128 Yoke
128a Magnetic pole surface
128b Magnetic pole surface
129a Coil
131 Slit
131 Main slit
132 Subsidiary slit
281 Bobbin
S1 Projection length of projecting electrostatic shield plate
S2 Distance from projecting electrostatic shield plate to aperture window
Vn Noise voltage
Vn0 Noise voltage in case where projecting electrostatic shield plate is not provided
Vs Signal voltage
Vs0 Signal voltage in case where projecting electrostatic shield plate is not provided
L Depth dimension
N Reciprocation direction
P Charged member

1. An ion generator that blows air ions generated by applying a high voltage to a discharge unit including discharge electrodes and counter electrodes, toward a charged member, the ion generator comprising:
a potential sensor provided integrally in a main body unit to measure potential of the charged member; and
a projecting electrostatic shield plate disposed between the discharge unit and the potential sensor to project from the main body unit.

2. The ion generator according to claim 1, wherein a projection length of the projecting electrostatic shield plate is in a range of 8 to 10 mm.

3. The ion generator according to claim 1, wherein
an aperture window is formed in the potential sensor to take in an electric field from the charged member, and
a distance from the projecting electrostatic shield plate to the aperture window in the potential sensor is 2 mm or less.

4. The ion generator according to claim 3, wherein
a blow-off opening is formed in the main body unit to blow-off the air ions,
a plurality of the discharge electrodes is disposed at intervals along the blow-off opening, and
the projecting electrostatic shield plate intervenes between any of the discharge electrodes and the aperture window.

5. The ion generator according to claim 4, wherein the blow-off opening and the aperture window are disposed on same plane in the main body.
